(19) United States
(12) Patent Application Publication
(10) Pub. No.: US 2012/0085928 A1
(43) Pub. Date: Apr. 12, 2012

(54) FLUORESCENCE DETECTION OPTICAL SYSTEM AND MULTI-CHANNEL FLUORESCENCE DETECTION SYSTEM INCLUDING THE SAME

(75) Inventors: Wong-jong JUNG, Seongnam-si (KR); Kak NAMKOONG, Seoul (KR); Joon-ho KIM, Seongnam-si (KR); Won-seok CHUNG, Suwon-si (KR); Hyung-sok YEO, Hwaseong-si (KR)

(73) Assignee: SAMSUNG ELECTRONICS CO., LTD., Suwon-si (KR)

(21) Appl. No.: 13/160,668

(22) Filed: Jun. 15, 2011

(30) Foreign Application Priority Data
Oct. 7, 2010 (KR) 10-2010-0097987

(51) Int. Cl. G01N 21/64

(52) U.S. Cl. 250/458.1

(57) ABSTRACT

A fluorescence detection optical system comprises a light source which emits excitation light, a collimating lens which condenses the excitation light emitted from the light source into substantially parallel light, an objective lens which focuses the excitation light on a microchamber of a microfluidic device, an optical detector which measures an intensity of a fluorescence signal generated in the microchamber by the excitation light, a beam splitter which transmits or reflects the excitation light emitted from the light source toward the objective lens, and reflects or transmits the fluorescence signal generated in the microchamber toward the optical detector, and a beam shaping lens which is disposed between the beam splitter and the objective lens and expands an optical spot of the excitation light in one direction in accordance with a shape of the microchamber.

### CROSS-REFERENCE TO RELATED APPLICATIONS

This application claims priority to Korean Patent Application No. 10-2010-0097987, filed on Oct. 7, 2010, and all the benefits accruing therefrom under 35 U.S.C. §119, the content of which in its entirety is herein incorporated by reference.

### BACKGROUND

1) Field

The present disclosure generally relates to a fluorescence detection optical system and a multi-channel fluorescence detection apparatus including the same, and more particularly, to a fluorescence detection optical system capable of entirely providing a microchamber of a microfluidic device with excitation light by expanding an optical spot of the excitation light in a direction of at least one axis in accordance with a shape of the microchamber, and a multi-channel fluorescence detection apparatus including the fluorescence detection optical system.

2) Description of the Related Art

In accordance with the advent of point of care diagnosis, various medical experiments such as gene analysis, external diagnosis, and nucleic acid sequence analysis, for example, have become important, and demand therefor has been increasing. Accordingly, systems for expediting a substantially large amount of experiments using a substantially small amount of samples have been developed and released. To provide such systems, microfluidic devices, such as microfluidic chips or lab-on-a-chips (“LOCs”), are receiving attention. Microfluidic devices including a plurality of microfluids and microchambers are designed to control and manipulate a substantially small amount of fluids, for example, from several nanoliters (nl) through to several microleters (ml). Microfluidic devices substantially minimize a reaction time of microfluids, simultaneously react to microfluids, and measure reaction results. Microfluidic devices may be manufactured using various methods, and may be formed of various materials according to manufacturing methods.

Meanwhile, during gene analysis, for example, to accurately determine whether a sample includes specific deoxyribonucleic acid (“DNA”) or an amount of the specific DNA, a process of refining/extracting a real sample and sufficiently amplifying the refined/extracted sample is needed. Polymerase chain reaction (“PCR”) is most widely used among various methods of amplifying a gene. A fluorescence detection method is mainly used to detect a DNA amplified through PCR. For example, real-time quantitative PCR (“qPCR”) uses a plurality of fluorescent dyes/probes and primer sets to amplify a target sample and detect/measure the amplified target sample in real time. For example, qPCR uses a fluorescence characteristic by cutting a TaqMan probe from a template during DNA amplification. More specifically, as a PCR cycle develops, a number of TaqMan probes cut from templates exponentially increases, and thus a fluorescence signal level exponentially increases. Such an increase in the fluorescence signal level is measured using an optical system, which enables determination of whether the target sample includes certain DNA or performance of quantitative analysis. As the PCR cycle develops, the fluorescence signal level forms an S-curve. A threshold cycle (“Ct”) value is set and measured at a point where the fluorescence signal level rapidly changes. Platforms, to which such qPCR is applied, have been commercialized in various experimental analyses such as external diagnosis, gene analysis, development of a biomarker, and nucleic acid sequence analysis.

For a fluorescence detection optical system measuring a fluorescence signal level or a change of the fluorescence signal level according to a bio reaction, such as PCR that occurs in a microfluidic device including a small amount of fluids ranged from several nl through to several ml, it needs to be considered that a depth of a microchamber of the microfluidic device is merely between several micrometers (μm) and several millimeters (mm). Accordingly, a shape of the microchamber is close to that of a 2D chamber having a substantially small depth compared to a width and a length. In this regard, sizes of the microchamber and excitation light must be considered together so as to sufficiently excite a fluorescence dye. Also, reactions that occur in a plurality of microchambers are necessarily measured quickly to improve analysis speed. In addition, two or more target samples at one time, i.e. two or more fluorescent dyes, are necessarily measured.

When light emitting diodes (“LEDs”) are used as a light source of the fluorescence detection optical system, an area of excitation light is restricted to a size and a shape of the LEDs. That is, an area where fluorescent dyes are excited in microchambers is restricted to the size and the shape of the LEDs. However, since an area of microchambers may be designed to be ranged between several square millimeters (mm²) and several hundreds mm² according to an amount of samples, the area of the excitation light emitted by the LEDs may be substantially smaller than that of the microchambers. To solve this problem, a size or a number of LEDs may be increased. However, an excessive increase in the size or the number of LEDs causes an increase in the fluorescence detection optical system, which increases a whole size of a detection system, and deteriorates heating due to the LEDs. Furthermore, a substantially small increase in a circular or rectangular area of excitation light may cause interference by other microchambers adjacent to a microchamber to be measured.

### SUMMARY

Provided is a fluorescence detection optical system capable of entirely providing a microchamber of a microfluidic device with excitation light by expanding an optical spot of the excitation light in a direction of at least one axis in accordance with a shape of the microchamber, and a multi-channel fluorescence detection apparatus including the fluorescence detection optical system.

Additional aspects will be set forth in part in the description which follows and, in part, will be apparent from the description, or may be learned by practice of the presented aspects of the present invention.

According to an aspect of the present invention, a fluorescence detection optical system includes a light source which emits excitation light, a collimating lens which condenses the excitation light emitted from the light source into substantially parallel light, an objective lens which focuses the excitation light on a microchamber of a microfluidic device, an optical detector which measures an intensity of a fluorescence signal generated in the microchamber by the excitation light, a beam splitter which transmits or reflects the excitation light emitted from the light source toward the objective lens, and reflects or transmits the fluorescence signal generated in the microchamber toward the optical detector, and a beam shaping lens which is disposed between the beam splitter and the objective lens and expands an optical spot of the excitation light in one direction in accordance with a shape of the microchamber.

In an aspect of the present invention, the fluorescence detection optical system may further include a first filter which is disposed between the collimating lens and the beam splitter and for transmits an excitation light component of a wavelength that excites a fluorescence dye of the microchamber, from among wavelengths of the excitation light emitted from the light source.

In an aspect of the present invention, the fluorescence detection optical system may further include a focusing lens which is disposed between the beam splitter and the optical detector and focuses a fluorescence signal of the microchamber on the optical detector.

In an aspect of the present invention, the fluorescence detection optical system may further include a second filter which is disposed between the beam splitter and the focusing lens and removes a fluorescence signal of another microchamber adjacent to the microchamber, and a third filter which is disposed between the second filter and the focusing lens and removes light of the excitation light component.

In an aspect of the present invention, the beam shaping lens may have refractive power in a first direction including an optical axis, and has no refractive power in a second direction including an optical axis substantially perpendicular to the first direction.

In an aspect of the present invention, the beam shaping lens may include one or more lens elements.

In an aspect of the present invention, the one or more lens elements may include cylindrical lenses or oval lenses.

In an aspect of the present invention, the beam shaping lens may include a plano-convex lens in which an incident surface is convex and an exit surface is flat, and a plano-concave lens in which an incident surface is concave and an exit surface is flat, when viewed from a cross-section of the beam shaping lens in the first direction.

In an aspect of the present invention, the plano-convex lens and the plano-concave lens may have no refractive power and are flat, when viewed from a cross-section of the beam shaping lens in the second direction.

In an aspect of the present invention, the beam shaping lens may have relatively large refractive power in the first direction including the optical axis, and have relatively small refractive power in the second direction including the optical axis substantially perpendicular to the first direction.

According to another aspect of the present invention, a multichannel fluorescence detection device includes a frame, a fluorescence detection module which moves back and forth in a direction in which a plurality of microchambers of a microfiuidic device are arranged, and detects a plurality of fluorescence signals generated in the plurality of microchambers, and a driving unit which moves the fluorescence detection module relative to the frame, wherein the fluorescence detection module may include one or more fluorescence detection optical systems.

In an aspect of the present invention, the driving unit may include a driving motor disposed in one side of the frame, and a lead screw rotated by the driving motor.

In an aspect of the present invention, the multichannel fluorescence detection device may further include a guide bar attached to the frame so as to guide the movement of the fluorescence detection module.

In an aspect of the present invention, the fluorescence detection module may include a connection member which is coupled to the lead screw and moves the fluorescence detection module according to the rotation of the lead screw, and a holder which is coupled to the guide bar and guides the movement of the fluorescence detection module.

In an aspect of the present invention, the multichannel fluorescence detection device may further include two or more location sensors which are disposed in sidewalls of the frame in the direction in which the fluorescence detection module moves, and detect a location of the fluorescence detection module.

In an aspect of the present invention, the two or more location sensors may include a first location sensor disposed corresponding to the first microchamber of the microfluidic device and a second location sensor disposed corresponding to a last microchamber of the microfluidic device.

### BRIEF DESCRIPTION OF THE DRAWINGS

The above and/or other aspects, advantages and features of this disclosure will become more apparent and more readily appreciated from the following description of the embodiments, taken in conjunction with the accompanying drawings of which:

FIG. 1 is a schematic view of an embodiment of an optical fluorescence detection optical system according to the present invention;

FIGS. 2A and 2B are cross-sectional views of the embodiment of an illumination optical system of the fluorescence detection optical system of FIG. 1 along with an optical path from a light source to a microfluidic device, wherein FIG. 2A is a cross-sectional view of the embodiment of the illumination optical system in a first direction including an optical axis, and FIG. 2B is a cross-sectional view of the illumination optical system in a second direction including an optical axis substantially perpendicular to the first direction;

FIG. 3 is a perspective view of an illumination optical system of the embodiment of the fluorescence detection optical system of FIG. 1 along with an optical path from a light source to a microfluidic device;

FIG. 4 is a plan view illustrating an embodiment of a light source having a light emitting diode (“LED”) array including a plurality of LEDs;

FIG. 5 is a plan view illustrating an embodiment of optical spots of excitation light focused on a microchamber of a microfluidic device;

FIG. 6 is a plan view illustrating an embodiment of a microchamber of a microfluidic device and an optical spot of excitation light focused on the microchamber;

FIGS. 7A and 7B are cross-sectional views of an embodiment of a detection optical system of the fluorescence detection optical system of FIG. 1 along with an optical path from a microfluidic device to an optical detector, wherein, FIG. 7A is a cross-sectional view of the detection optical system in a first direction including an optical axis, and FIG. 7B is a cross-sectional view of the detection optical system in a second direction including an optical axis substantially perpendicular to the first direction;

FIG. 8 is a plan view illustrating an embodiment of optical spots of fluorescence signals focused on an optical detector;

FIG. 9 is a perspective view of an embodiment of a multichannel fluorescence detection device according to the present invention;

FIG. 10 is another perspective view of the embodiment of the multichannel fluorescence detection device of FIG. 9 according to the present invention;

FIG. 11 is a perspective view of an embodiment of a plurality of microchambers arranged in a microfluidic device according to the present invention; and

FIG. 12 is a graph of an embodiment of a result obtained by scanning the embodiment of the microchambers of FIG. 11 using the embodiment of the multichannel fluorescence detection device of FIGS. 9 and 10 according to the present invention.

### DETAILED DESCRIPTION

Aspects of the present invention will be described more fully hereinafter with reference to the accompanying drawings, in which exemplary embodiments of the invention are shown. As those skilled in the art would realize, the described embodiments may be modified in various different ways, all without departing from the spirit or scope. In the drawing, parts having no relationship with the explanation are omitted for clarity, and the same or similar reference numerals designate the same or similar elements throughout the specification.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the present invention will be described in further detail with reference to the accompanying drawings.

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

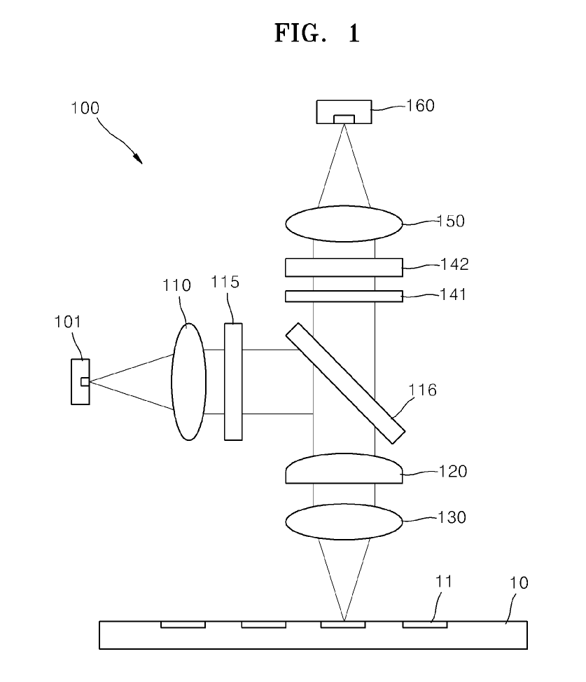

FIG. 1 is a schematic view of an embodiment of a fluorescence detection optical system 100 according to the present invention. The present embodiment of the fluorescence detection optical system 100 may include an illumination optical system for illuminating a microchamber 11 of a microfluidic device 10 through excitation light and a detection optical system for detecting a fluorescence signal generated in the microchamber 11 by the excitation light.

Referring to FIG. 1, the illumination optical system, for example, may include a light source 101 that emits light, a collimating lens 110 that condenses the light emitted from the light source 101 into parallel light, a first filter 115 that passes an excitation light component having a wavelength that excites a fluorescence dye from the light emitted from the light source 101, a beam splitter 116 that reflects excitation light toward the microfluidic device 10, an objective lens 130 that focuses the excitation light on the microchamber 11 of the microfluidic device 10, and a beam shaping lens 120 that is disposed between the beam splitter 116 and the objective lens 130 and expands an optical spot of the excitation light in a direction of one axis in accordance with the microchamber 11. In the present embodiment, the light source 101 may be, for example, a light emitting diode (“LED”) or a laser diode (“LD”) that emits light having a wavelength of about 400 nanometers (nm) and about 700 nm, respectively. However, the light source 101 is not limited thereto and may include other various types of light sources. Although each of the collimating lens 110, the beam shaping lens 120, and the objective lens 130 is shown as a single lens element in FIG. 1 for descriptive convenience, in one embodiment, each of the collimating lens 110, the beam shaping lens 120, and the objective lens 130 may be a combination of a plurality of lens elements. Further, the first filter 115 may be for example, a band pass filter (“BPF”) that passes light having a specific wavelength band. However, the first filter 115 is not limited thereto and may include other various types of filters.

Still referring to FIG. 1, the detection optical system may include the beam splitter 116 that transmits the fluorescence signal generated in the microchamber 11, a second filter 141 that removes a fluorescence signal from other microchambers adjacent to the microchamber 11, a third filter 142 that removes light of the excitation light component, a optical detector 160 that measures intensity of the fluoresence signal and converts the fluoresence signal into an equivalent electrical signal, and a focusing lens 150 that is disposed between the optical detector 160 and the third filter 142 and focuses the fluoresence signal on the optical detector 160. The objective lens 130 may condense the fluorescence signal generated in the microchamber 11 into parallel light in the detection optical system. The beam shaping lens 120 may deform an optical spot of the fluorescence signal generated in the microchamber 11 in accordance with a shape of the optical detector 160 in the detection optical system. In the present embodiment, the optical detector 160 may include, for example, an array of a plurality of photo diodes, a charge-coupled device (“CCD”) image sensor, or a complementary metal oxide semiconductor (“CMOS”) image sensor. However, the optical detector 160 is not limited thereto and may include other various types of image sensors. Although the focusing lens 150 is shown as a single lens element in FIG. 1 for descriptive convenience, in one embodiment, the focusing lens 150 may be a combination of a plurality of lens elements. Meanwhile, the second filter 141 that prevents interference of other microchambers adjacent to the microchamber 11 may be, for example, a high pass filter (“HPF”) that passes light having a wavelength band higher than a specific wavelength band. In one embodiment, if a plurality of micro-channels are not simultaneously measured but are measured one by one, the second filter 141 may not be included in the detection optical system. The third filter 142 may be, for example, a BPF that passes light having a specific wavelength band, but is not limited thereto and may include other various types of filters.

Therefore, the illumination optical system and the detection optical system may share the beam splitter 116, the beam shaping lens 120, and the objective lens 130. In the present embodiment, excitation light generated in the light source 101 is reflected by the beam splitter 116, and the fluorescence signal generated in the microchamber 11 transmits the beam splitter 116. That is, an optical path of the excitation light is folded almost at a right angle by the beam splitter 116, and an optical path of the fluorescence signal is straight. However, in one embodiment, the beam splitter 116 may be designed to transmit the excitation light and reflect the fluorescence signal. In the above mentioned embodiment, the optical path of the excitation light may be straight, and the optical path of the fluorescence signal may be folded almost at a right angle. In this connection, the beam splitter 116 may transmit or reflect the excitation light emitted from the light source 101 toward the objective lens 130, and reflect or transmit the fluorescence signal generated in the microchamber 11 toward the optical detector 160. In one embodiment, the beam splitter 116 that separates the optical path of the excitation light and the optical path of the fluorescence signal may be, for example, a dichroic mirror that transmits light of a specific wavelength and reflects light of remaining wavelengths, or reflects light of a specific wavelength and transmits light of remaining wavelengths, for example, but is not limited thereto and may include other various types of mirrors.

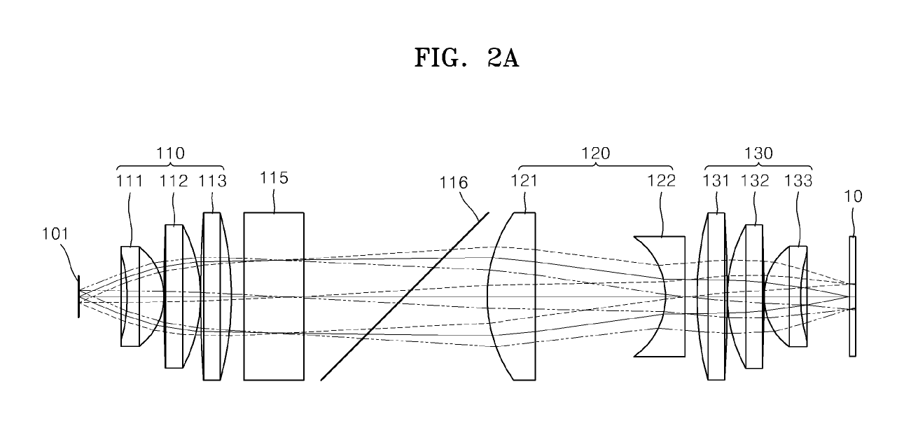

FIGS. 2A and 2B are cross-sectional views of an illumination optical system of the embodiment of the fluorescence detection optical system 100 of FIG. 1 along with an optical path from the light source 101 to the microfluidic device 10. FIG. 2A is an embodiment of a cross-sectional view of the illumination optical system in a first direction including an optical axis. FIG. 2B is a cross-sectional view of the illumination optical system in a second direction including an optical axis substantially perpendicular to the first direction. Referring to FIGS. 2A and 2B, each of optical devices of the illumination optical system are arranged in a straight line for descriptive convenience. Also, FIGS. 2A and 2B show paths in which three lights emitted from three points on the light source 101 are focused on the microfluidic device 10.

Referring to FIG. 2A showing the cross-sectional view of the embodiment of the illumination optical system in the first direction, the collimating lens 110 may include, for example, first through third lens elements 111, 112, and 113. For example, the first lens element 111 may be a concave-convex lens in which an incident surface is concave and an exit surface is convex, the second lens element 112 may be a plano-convex lens in which an incident surface is flat and an exit surface is convex, and the third lens element 113 may be a biconvex lens in which an incident surface is relatively less convex and an exit surface is relatively more convex. However, the first, second, and third lens elements 111, 112, 113 are not limited thereto and may include other various shapes of lens elements. The beam shaping lens 120 may include fourth and fifth lens elements 121 and 122. The fourth lens element 121 may be, for example, a plano-convex lens in which an incident surface is convex and an exit surface is flat, and the fifth lens element 122 may be, for example, a plano-concave lens in which an incident surface is concave and an exit surface is flat. However, the fourth and fifth lens elements 121 and 122 are not limited thereto and may include other various types of lens elements. Finally, the objective lens 130 may include sixth through eighth lens elements 131, 132, and 133. In one embodiment, the sixth lens element 131 may be a biconvex lens in which an incident surface is relatively more convex and an exit surface is relatively less convex, the seventh lens element 132 may be a plano-convex lens in which an incident surface is convex and an exit surface is flat, and the eighth lens element 133 may be a concave-convex lens in which an incident surface is convex and an exit surface is concave, for example.

Referring to FIG. 2B showing a cross-sectional view of an embodiment of the illumination optical system in the second direction, the first through third lens elements 111, 112, and 113 and the sixth through eighth lens elements 131, 132, and 133 are substantially the same as those of the embodiment of FIG. 2A showing the cross-sectional view of the illumination optical system in the first direction. Thus, the first through third lens elements 111, 112, and 113 and the sixth through eighth lens elements 131, 132, and 133 are substantially symmetrical with respect to the optical axis, and thus both the first direction and the second direction have positive refractive power.

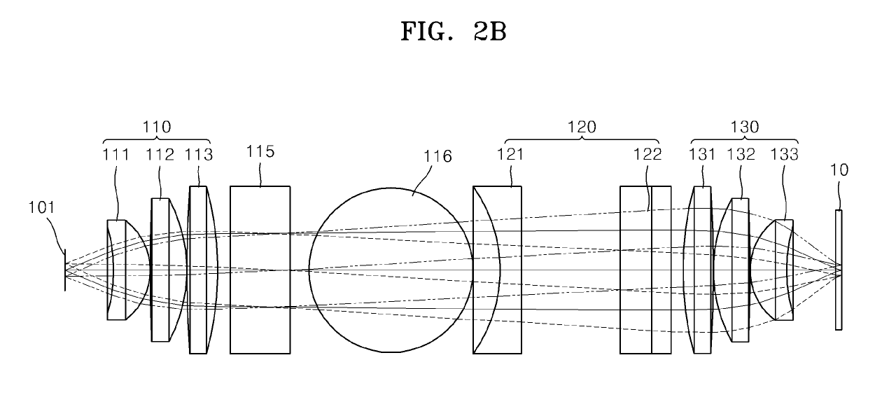

Meanwhile, the fourth and fifth lens elements 121 and 122 of the beam shaping lens 120 of FIG. 2B are flat without refractive power in the second direction. Thus, the beam shaping lens 120 has refractive power in the first direction and have no refractive power in the second direction. To easily understand shapes of the fourth and fifth lens elements 121 and 122, a perspective view of the embodiment of the illumination optical system of the fluorescence detection optical system 100 of FIG. 1 along with an optical path from the light source 101 to the microfluidic device 10 is shown in FIG. 3. FIG. 2A is the cross-sectional view of the illumination optical system of FIG. 3 in a direction of an x-axis. FIG. 2B is the cross-sectional view of the illumination optical system of FIG. 3 in a direction of a y-axis. Referring to FIG. 3, the fourth and fifth lens elements 121 and 122 may be, for example, cylindrical. Alternatively, the fourth and fifth lens elements 121 and 122 may be, for example, oval lenses having relatively great refractive power in the first direction and relative small refractive power in the second direction. However, the fourth and fifth lens elements 121 and 122 are not limited thereto and may include other various shapes of lens elements.

According to an embodiment of the present invention, a combination of the collimating lens 110 and the objective lens 130 may be designed to have a magnification of 1 as a whole, whereas the beam shaping lens 120 may be designed to have a magnification greater than 1 in the first direction. Thus, since a magnification of the illumination optical system in the first direction is greater than 1 as a whole, as shown in FIG. 2A, widths of three points focused on the microfluidic device 10 may be substantially greater (e.g., about 1.5 to 3 times) than those of three points on the light source 101 in the first direction. Meanwhile, since the magnification of the beam shaping lens 120 is approximately close to 1 in the second direction, a magnification of the illumination optical system in the second direction is close to 1 as a whole. Therefore, as shown in FIG. 2B, widths of three points on the light source 101 may be almost same as those of three points focused on the microfluidic device 10 in the second direction.

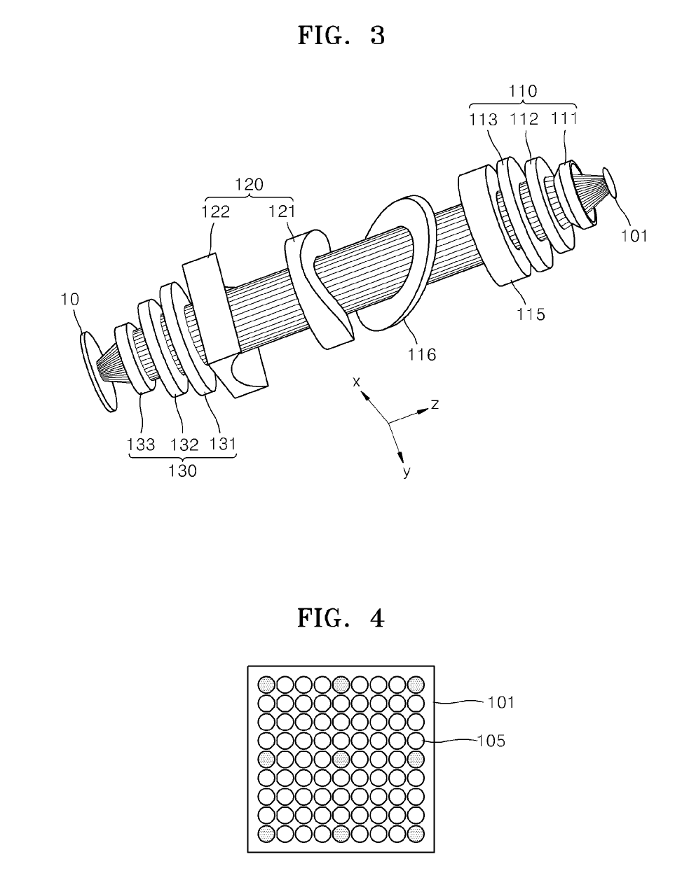

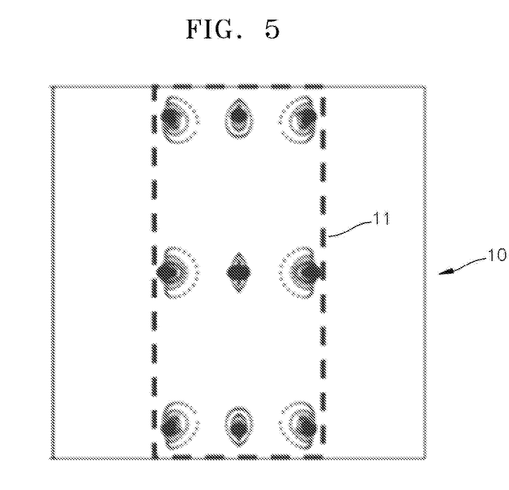

In one embodiment, referring to FIG. 4 which illustrates the light source 101 having a light emitting diode (“LED”) array including a plurality of LEDs 105, nine (circled in black) of the plurality of LEDs 105 arranged in a rectangular shape are turned on and emit light, for example. In the present embodiment, referring to FIG. 5, which exemplarily illustrates nine optical spots of excitation light focused on the microchamber 11 of the microfluidic device 10, the nine optical spots may be arranged in a rectangular shape by the beam shaping lens 120. If all of the plurality of LEDs 105 of the light source 101 emit light, a homogeneous optical spot in the rectangular shape may be formed on the microchamber 11 of the microfluidic device 10. In one embodiment, if the light source 101 has an array of 1 millimeter (mm)×1 mm, for example, excitation light emitted from the light source 101 may expand in the first direction by the beam shaping lens 120 and have an optical spot of about 1 mm×2.4 mm on the microchamber 11.

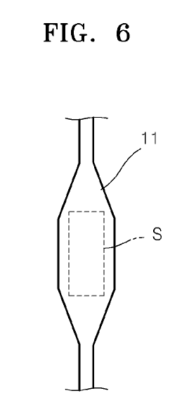

Then, referring to FIG. 6 which exemplarily illustrates the microchamber 11 of the microfluidic device 10 and an optical spot S of excitation light focused on the microchamber 11, an optical spot S of excitation light may be formed in an almost overall region of the microchamber 11 which is elongated in one direction. Therefore, a fluorescence signal level by a small amount of biochemical reaction in the microfluidic device 10 and a variation of the fluorescence signal level may be more accurately measured. Furthermore, the light spot S of the excitation light that expands in the first direction does not illuminate regions of other microchambers adjacent to the microchamber 11, and thus interference may not occur due to other microchambers adjacent to the microchamber 11.

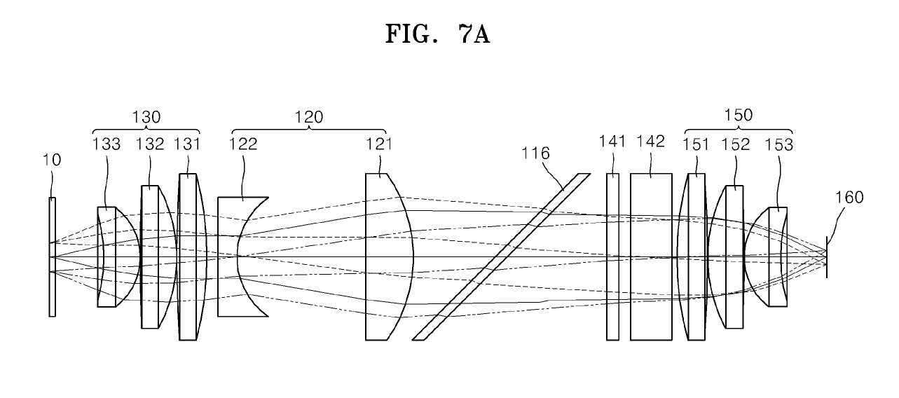

FIGS. 7A and 7B are cross-sectional views of an embodiment of a detection optical system of the fluorescence detection optical system 100 of FIG. 1 along with an optical path from the microfluidic device 10 to the optical detector 160. FIG. 7A is a cross-sectional view of the detection optical system in a first direction including an optical axis. FIG. 7B is a cross-sectional view of the detection optical system in a second direction including an optical axis substantially perpendicular to the first direction. That is, FIG. 7A is a cross-sectional view in a substantially same direction as that of the embodiment shown in FIG. 2A. FIG. 7B is a cross-sectional view in a substantially same direction as that of the embodiment shown in FIG. 2B. Referring to FIGS. 7A and 7B, each of optical devices of the detection optical system are arranged in a straight line for descriptive convenience, but is not limited thereto. Also, FIGS. 7A and 7B show paths in which three fluorescence signals generated in three points on the microfluidic device 10 are focused on the optical detector 160, but are not limited thereto.

Referring to FIGS. 7A and 7B, in one embodiment, the three fluorescence signals generated by exciting a fluorescence dye of a sample using excitation light in the microfluidic device 10 are focused on the optical detector 160 through the objective lens 130, the beam shaping lens 120, the second filter 141, the third filter 142, and the focusing lens 150. In the present embodiment, structures of the objective lens 130 and the beam shaping lens 120 may be the same as those of the embodiment of FIGS. 2A and 2B. The focusing lens 150 may include, for example, ninth through eleventh lens elements 151, 152, and 153. In one embodiment, the ninth lens element 151 may be a biconvex lens in which an incident surface is relatively more convex and an exit surface is relatively less convex, the tenth lens element 152 may be a plano-convex lens in which an incident surface is convex and an exit surface is flat, and the eleventh lens element 153 may be a concave-convex lens in which an incident surface is convex and an exit surface is concave, for example. However, the ninth through eleventh lens elements 151, 152, and 153 are not limited thereto and may include other various shapes of lens elements.

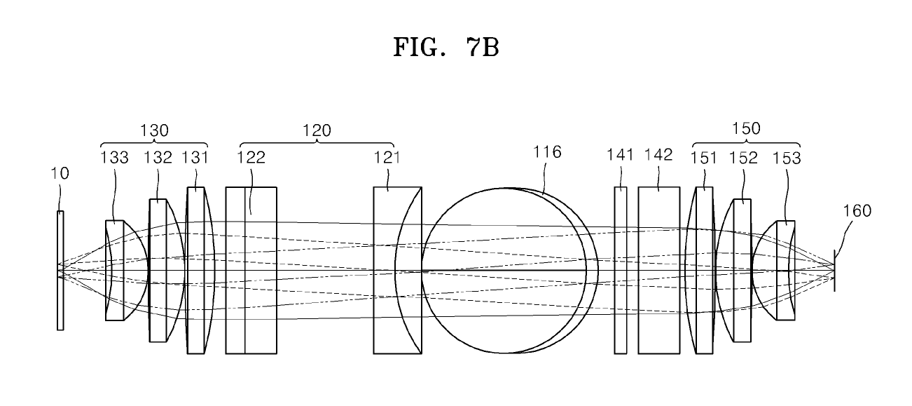

In one embodiment, a magnification of the focusing lens 150 may be designed to be slightly greater than 1. Then, for example, if the light source 101 has an array of 1 mm×1 mm, excitation light emitted from the light source 101 may expand in the first direction by the beam shaping lens 120 and have an optical spot of about 1 mm×2.4 mm on the microchamber 11. The fluorescence signals generated in the microchamber 11 by the excitation light may be focused on the optical detector 160 of about 1.3 mm×1.3 mm by the focusing lens 150 through the objective lens 130 and the beam shaping lens 120. Referring to FIG. 7A, widths of the fluorescence signals become smaller through the objective lens 130, the beam shaping lens 120, and the focusing lens 150 in the first direction, whereas widths of the fluorescence signals become slightly greater in the second direction, since, as described above, the beam shaping lens 120 has refractive power in the first direction and has no refractive power in the second direction. FIG. 8 exemplarily illustrates nine fluorescence signals that are generated in the microchamber 11 of the microfluidic device 10 and are focused on the optical detector 160 when nine of the plurality of LEDs 105 of FIG. 4 arranged in the rectangular shape are turned on and emit light. Referring to FIG. 8, optical spots of the fluorescence signals are arranged in an almost rectangular shape in the optical detector 160 by the objective lens 130, the beam shaping lens 120, and the focusing lens 150.

The structure and operation of an exemplary embodiment of the fluorescence detection optical system 100 according to the present invention are described. Although each of the collimating lens 110, the objective lens 130, and the focusing lens 150 includes three lens elements in the embodiments described above, the present invention is not limited thereto. In other embodiments, for example, types and number of lens elements may be modified according to a wavelength of excitation light, a wavelength of a fluorescence signal, a size and shape of a microchamber, spaces between adjacent microchambers, and a size and shape of an optical detector, for example. Further, although the beam shaping lens 120 includes two cylindrical lenses in the embodiments described above, the present invention is not limited thereto. In other embodiments, for example, the beam shaping lens 120 may include oval lenses, or a combination of cylindrical lenses and oval lenses. Further, the beam shaping lens 120 may include a single lens element or three or more lens elements.

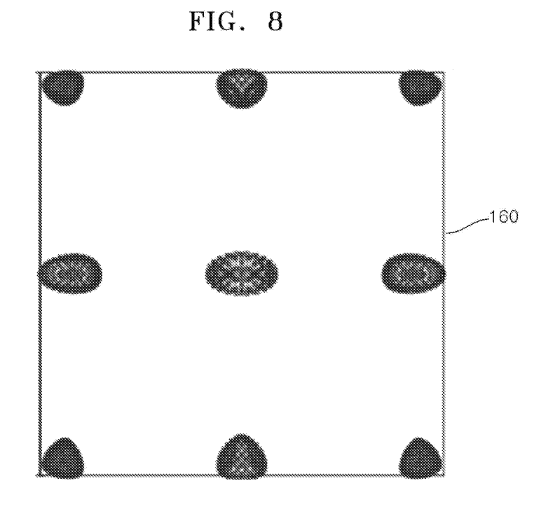

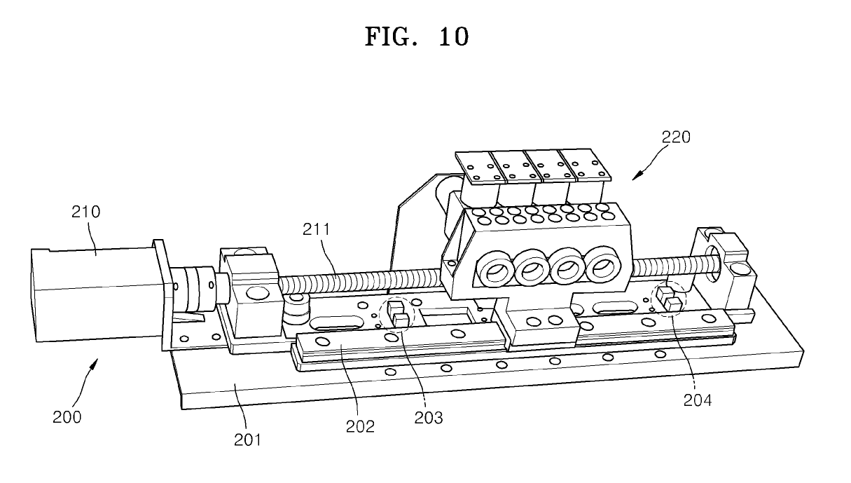

Meanwhile, FIG. 9 is a perspective view of an embodiment of a multichannel fluorescence detection device 200 according to the present invention. Referring to FIG. 9, in the present embodiment, the multichannel fluorescence detection device 200 is configured to move back and forth in a direction which microchambers 11 through 18 (refer to FIG. 11) of the microfluidic device 10 are arranged, and simultaneously detect fluorescence signals generated in the microchambers 11 through 18. To this end, the multichannel fluorescence detection device 200 of the present embodiment may include a frame 201, a driving motor 210 that is disposed in one side of the frame 201, a lead screw 211 that rotates by the driving motor 210, a fluorescence detection module 220 that moves back and forth in the direction which the microchambers 11 through 18 are arranged according to the rotation of the lead screw 211, and a guide bar 202 that is attached to the frame 201 to guide a movement of the fluorescence detection module 220. In this regard, the driving motor 210 and the lead screw 211 constitute a driving unit that relatively moves the fluorescence detection module 220 with respect to the frame 201. Further, the fluorescence detection module 220 may include a connection member 221 that is coupled to the lead screw 211 and moves the fluorescence detection module 220 according to a rotation of the lead screw 211, a holder 225 that is coupled to the guide bar 202 and guides a movement of the fluorescence detection module 220, and the fluorescence detection optical system 100 that detects the fluorescence signals from the microchambers 11 through 18.

The embodiments of the fluorescence detection optical system 100 are described above with reference to FIGS. 1 through 8. The fluorescence detection module 220 may include a plurality of fluorescence detection optical systems 100 that are disposed in parallel to each other in order to simultaneously measure the microchambers 11 through 18. In one embodiment, for example, the fluorescence detection module 220 may include four fluorescence detection optical systems 100 in FIG. 9. However, the number of the fluorescence detection optical systems 100 is not limited thereto. In one embodiment, the guide bar 202 attached to the frame 201 and the holder 225 of the fluorescence detection module 220 may be included in a rectilinear motion guide that minimizes a mechanical vibration during the movement of the fluorescence detection module 220.

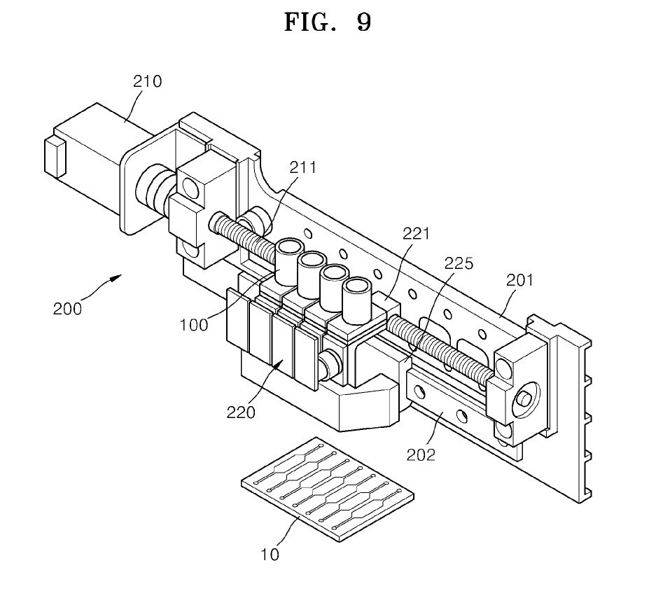

FIG. 10 is a perspective view of the exemplary embodiment of the multichannel fluorescence detection device 200 of FIG. 9 according to embodiment of the present invention. Referring to FIG. 10, at least two location sensors 203 and 204 may be disposed in sidewalls of the frame 201 in a direction in which the fluorescence detection module 220 moves. The first and second location sensors 203 and 204 detect a location of the fluorescence detection module 220 so that the fluorescence detection module 220 starts scanning at an accurate scanning start location and ends scanning at an accurate scanning end location while scanning the microchambers 11 through 18. In one embodiment, for example, the first location sensor 203 may be disposed corresponding to the first microchamber 11 of the microfluidic device 10, and the second location sensor 204 may be disposed corresponding to the last microchamber 18 of the microfluidic device 10.

Then, when the multichannel fluorescence detection device 200 performs scanning, the fluorescence detection module 220 moves left or right until the first location sensor 203 detects the fluorescence detection module 220. If the first location sensor 203 detects the fluorescence detection module 220, the fluorescence detection module 220, for example, moves right from a location where the fluorescence detection module 220 is detected and starts scanning the microchambers 11 through 18. If the second location sensor 204 detects the fluorescence detection module 220, the fluorescence detection module 220 determines that the microchambers 11 through 18 are completely scanned and ends scanning of the microchambers 11 through 18. The first and second location sensors 203 and 204 may be, for example, non-contact sensors, such as an infrared sensor, a visible ray sensor, or an RF sensor, or contact sensors, such as a pressure switch. Types of the first and second location sensors 203 and 204 are not particularly limited thereto, and may include various other types of sensors.

FIG. 11 is a perspective view of an exemplary embodiment of the microchambers 11 through 17 arranged in the microfluidic device 10 according to the present invention. In the present embodiment, the fluorescence detection module 220 of the multichannel fluorescence detection device 200 may simultaneously provide at least the microchambers 11 through 14 with optical spots S1 through S4 of excitation light using the fluorescence detection optical systems 100. Further, after the fluorescence detection module 220 completely performs fluorescence detection on the microchambers 11 through 14, the fluorescence detection module 220 moves to the microchambers 15 through 18 by rotating the driving motor 210. Thereafter, the fluorescence detection module 220 may simultaneously provide at least the microchambers 15 through 18 with the optical spots S1 through S4 of excitation light using the fluorescence detection optical systems 100, and perform fluorescence detection on the microchambers 15 through 18.

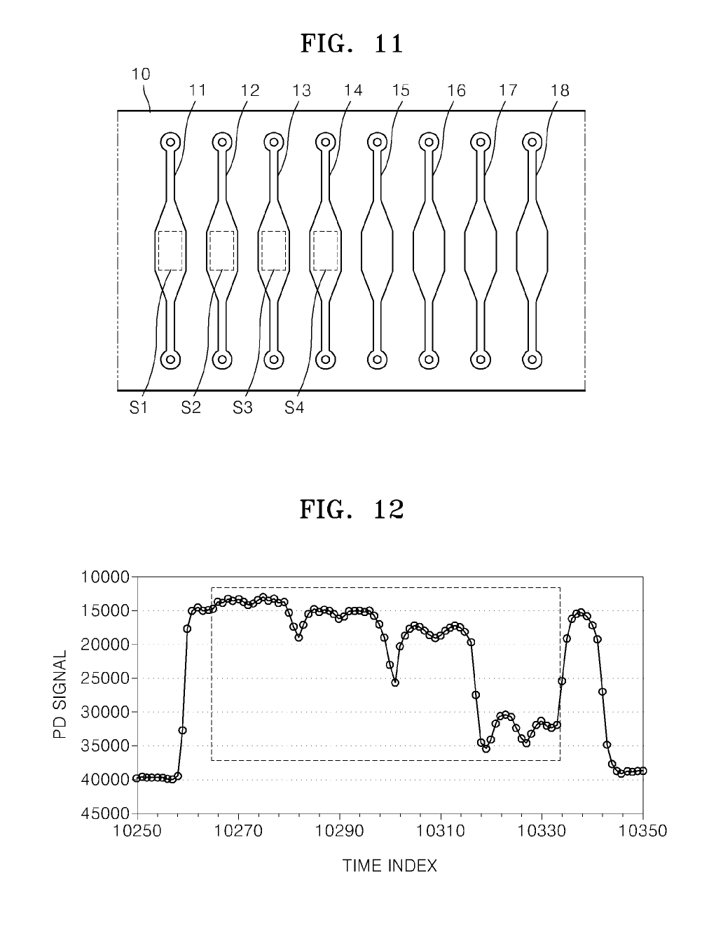

FIG. 12 is a graph of a result obtained by scanning the embodiment of the microchambers 11 through 18 of FIG. 11 using the embodiment of the multichannel fluorescence detection device 200 of FIGS. 9 and 10 according to the present invention. In one embodiment, for example, if a density of a sample of the first and second microchambers 11 and 12 is about 512 nanometers (nm), a density of a sample of the third and fourth microchambers 13 and 14 is about 128 nm, a density of a sample of the fifth and sixth microchambers 15 and 16 is about 32 nm, and a density of a sample of the seventh and eighth microchambers 17 and 17 is about 8 nm, referring to FIG. 12, the result obtained by scanning the microchambers 11 through 18 of the microfluidic device 10 using the present embodiment of the multichannel fluorescence detection device 200 shows a variation of a fluorescence signal level.

As described above, present embodiment of the multichannel fluorescence detection device 200 may scan the microchambers 11 through 18 formed in the microfluidic device 10 using the fluorescence detection module 220 including the one or more fluorescence detection optical systems 100 arranged in parallel to each other. Therefore, the multichannel fluorescence detection device 200 of the present embodiment may measure the microchambers 11 through 18 in real time only using the fluorescence detection module 220, and perform fluorescence detection from the microchambers 11 through 18 within a substantially short time.

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. A fluorescence detection optical system comprising:
a light source which emits excitation light;
a collimating lens which condenses the excitation light emitted from the light source into substantially parallel light;
an objective lens which focuses the excitation light on a microchamber of a microfluidic device;
an optical detector which measures an intensity of a fluorescence signal generated in the microchamber by the excitation light;
a beam splitter which transmits or reflects the excitation light emitted from the light source toward the objective lens, and reflects or transmits the fluorescence signal generated in the microchamber toward the optical detector; and
a beam shaping lens which is disposed between the beam splitter and the objective lens and expands an optical spot of the excitation light in one direction in accordance with a shape of the microchamber.

2. The fluorescence detection optical system of claim 1, further comprising:
a first filter which is disposed between the collimating lens and the beam splitter and transmits an excitation light component of a wavelength that excites a fluorescence dye of the microchamber, from among wavelengths of the excitation light emitted from the light source.

3. The fluorescence detection optical system of claim 1, further comprising:
a focusing lens which is disposed between the beam splitter and the optical detector and focuses a fluorescence signal of the microchamber on the optical detector.

4. The fluorescence detection optical system of claim 3, further comprising:
a second filter which is disposed between the beam splitter and the focusing lens and removes a fluorescence signal of another microchamber adjacent to the microchamber; and
a third filter which is disposed between the second filter and the focusing lens and removes light of the excitation light component.

5. The fluorescence detection optical system of claim 1, wherein the beam shaping lens has refractive power in a first direction including an optical axis, and has no refractive power in a second direction including an optical axis substantially perpendicular to the first direction.

6. The fluorescence detection optical system of claim 5, wherein the beam shaping lens comprises one or more lens elements.

7. The fluorescence detection optical system of claim 6, wherein the one or more lens elements comprise at least one of cylindrical lenses and oval lenses.

8. The fluorescence detection optical system of claim 5, wherein the beam shaping lens comprises a plano-convex lens in which an incident surface is convex and an exit surface is flat, and a plano-concave lens in which an incident surface is concave and an exit surface is flat, when viewed from a cross-section of the beam shaping lens in the first direction.

9. The fluorescence detection optical system of claim 8, wherein the plano-convex lens and the plano-concave lens have no refractive power and are flat, when viewed from a cross-section of the beam shaping lens in the second direction.

10. The fluorescence detection optical system of claim 1, wherein the beam shaping lens has relatively large refractive power in the first direction including the optical axis, and has relatively small refractive power in the second direction including the optical axis substantially perpendicular to the first direction.

11. A multichannel fluorescence detection device comprising:
a frame;
a fluorescence detection module which moves back and forth in a direction in which a plurality of microchambers of a microfluidic device are arranged, and detects a plurality of fluorescence signals generated in the plurality of microchambers; and
a driving unit which moves the fluorescence detection module relative to the frame,
wherein the fluorescence detection module comprises one or more fluorescence detection optical systems, the one or more fluorescence detection optical systems comprise:
a light source which emits excitation light;
a collimating lens which condenses the excitation light emitted from the light source into substantially parallel light;
an objective lens which focuses the excitation light on a microchamber of a microfluidic device;
an optical detector which measures an intensity of a fluorescence signal generated in the microchamber by the excitation light;
a beam splitter which transmits or reflects the excitation light emitted from the light source toward the objective lens, and reflects or transmits the fluorescence signal generated in the microchamber toward the optical detector; and
a beam shaping lens which is disposed between the beam splitter and the objective lens and expands an optical spot of the excitation light in one direction in accordance with a shape of the microchamber.

12. The multichannel fluorescence detection device of claim 11, wherein the driving unit comprises:
a driving motor disposed in one side of the frame; and
a lead screw rotated by the driving motor.

13. The multichannel fluorescence detection device of claim 12, further comprising:
a guide bar attached to the frame so as to guide the movement of the fluorescence detection module.

14. The multichannel fluorescence detection device of claim 13, wherein the fluorescence detection module comprises:
a connection member which is coupled to the lead screw and moves the fluorescence detection module according to the rotation of the lead screw; and
a holder which is coupled to the guide bar and guides the movement of the fluorescence detection module.

15. The multichannel fluorescence detection device of claim 11, wherein the one or more fluorescence detection optical systems further comprise:
a first filter which is disposed between the collimating lens and the beam splitter and transmits an excitation light component of a wavelength that excites a plurality of fluorescent dyes of the plurality of microchambers from among wavelengths of excitation light emitted from a light source.

16. The multichannel fluorescence detection device of claim 11, wherein the one or more fluorescence detection optical systems further comprise:
a focusing lens which is disposed between the beam splitter and the optical detector and focuses a plurality of fluorescence signals of the plurality of microchambers on the optical detector.

17. The multichannel fluorescence detection device of claim 16, wherein the one or more fluorescence detection optical systems further comprise:
a second filter which is disposed between the beam splitter and the focusing lens and removes a plurality of fluorescence signals of other microchambers adjacent to the plurality of microchambers; and
a third filter which is disposed between the second filter and the focusing lens and removes light of the excitation light component.

18. The multichannel fluorescence detection device of claim 11, wherein the beam shaping lens of the one or more fluorescence detection optical systems has refractive power in a first direction including an optical axis, and has no refractive power in a second direction including an optical axis substantially perpendicular to the first direction.

19. The multichannel fluorescence detection device of claim 18, wherein the beam shaping lens comprises one or more lens elements.

20. The multichannel fluorescence detection device of claim 19, wherein the one or more lens elements comprise at least one of cylindrical lenses and oval lenses.

21. The multichannel fluorescence detection device of claim 18, wherein the beam shaping lens comprises a plano-convex lens in which an incident surface is convex and an exit surface is flat, and a plano-concave lens in which an incident surface is concave and an exit surface is flat, when viewed from a cross-section of the beam shaping lens in the first direction.

22. The multichannel fluorescence detection device of claim 21, wherein the plano-convex lens and the plano-concave lens have no refractive power and are flat, when viewed from a cross-section of the beam shaping lens in the second direction.

23. The multichannel fluorescence detection device of claim 11, wherein the beam shaping lens of the one or more fluorescence detection optical systems has relatively large refractive power in the first direction including the optical axis, and has relatively small refractive power in the second direction including the optical axis substantially perpendicular to the first direction.

24. The multichannel fluorescence detection device of claim 11, further comprising:
two or more location sensors which are disposed in sidewalls of the frame in the direction in which the fluorescence detection module moves, and detect a location of the fluorescence detection module.

25. The multichannel fluorescence detection device of claim 24, wherein the two or more location sensors comprise a first location sensor disposed corresponding to the first microchamber of the microfluidic device and a second location sensor disposed corresponding to a last microchamber of the microfluidic device.
